(19) United States
(12) Patent Application Publication
(10) Pub. No.: US 2023/0251650 A1
(43) Pub. Date: Aug. 10, 2023

(54) REMOTE OPERATION SYSTEM, INFORMATION PROVIDING METHOD, AND REMOTE OPERATOR TERMINAL

(71) Applicant: Woven Planet Holdings, Inc., Tokyo (JP)

(72) Inventor: Yuki SUEHIRO, Ichikawa-shi (JP)

(73) Assignee: Woven Planet Holdings, Inc., Tokyo (JP)

(21) Appl. No.: 18/080,287

(22) Filed: Dec. 13, 2022

(30) Foreign Application Priority Data
Feb. 7, 2022 (JP) 2022-017453

(51) Int. Cl. G05D 1/00; G06T 5/00

(52) U.S. Cl. CPC G05D 1/0038; G06T 5/001; G06T 2207/30252

(57) ABSTRACT

A remote operation system provides information to a remote operator performing a remote operation of a moving body. The remote operation system acquires an image captured by a camera installed on the moving body. The remote operation system determines, based on the image, an environmental condition under which the image is captured. The remote operation system performs visibility improvement processing that improves visibility of the image according to the environmental condition. The remote operation system presents an improved image with the improved visibility to the remote operator. When the visibility improvement processing according to a weather condition among environmental conditions is performed, the remote operation system notifies the remote operator of assist information including weather at a position of the moving body.

### CROSS-REFERENCE TO RELATED APPLICATION

This application claims priority to Japanese Patent Application No. 2022-017453 filed on Feb. 7, 2022, the entire contents of which are incorporated by reference herein.

### BACKGROUND

### Technical Field

The present disclosure relates to a technique for providing information to a remote operator performing a remote operation of a moving body.

### Background Art

Patent Literature 1 discloses a technique for improving visibility of a local region with poor visibility while maintaining visibility of an entire image. More specifically, a shadow region in an image captured by an imaging device is recognized. Then, a pixel value of each pixel belonging to the shadow region is changed such that a feature amount (for example, luminance) of the shadow region coincides with the feature amount of the other region.

Non-Patent Literature 1 discloses an image recognition technique using ResNet (Deep Residual Net).

Non-Patent Literature 2 discloses a technique for recognizing a scene such as weather from an image by using Deep Residual Learning.

Non-Patent Literature 3 discloses a technique that uses a convolutional neural network (CNN) to improve a hazy image caused by fog and the like (dehazing, defogging).

Non-Patent Literature 4 discloses a technique (EnlightenGAN) that converts a low-illuminance image into a normal-light image by using deep learning. For example, this makes it possible to correct an image captured in a scene such as nighttime or backlight to have appropriate brightness.

Non-Patent Literature 5 discloses a technique for improving a hazy image caused by fog, rain, and the like (dehazing, deraining).

### List of Related Art

Patent Literature 1: Japanese Patent Application Laid-Open No. JP-2007-272477

Non-Patent Literature 1: Kaiming He, Xiangyu Zhang, Shaoqing Ren, and Jian Sun, “Deep Residual Learning for Image Recognition”, arXiv:1512.03385v1 [cs.CV], Dec. 10, 2015 (https://arxiv.org/pdf/1512.03385.pdf)

Non-Patent Literature 2: Mohamed R. Ibrahim, James Haworth, and Tao Cheng, “WeatherNet: Recognising weather and visual conditions from street-level images using deep residual learning”, arXiv:1910.09910v1 [cs.CV], Oct. 22, 2019 (https://arxiv.org/ftp/arxiv/papers/1910/1910.09910.pdf)

Non-Patent Literature 3: Boyi Li, Xiulian Peng, Zhangyang Wang, Jizheng Xu, and Dan Feng, “AOD-Net: All-in-One Dehazing Network”, ICCV, 2017 (https://openaccess.thecvf.com/content_ICCV_2017/papers/Li_AOD-Net_All-In-One_Dehazing_ICCV_2017_paper.pdf)

Non-Patent Literature 4: Yifan Jiang, Xinyu Gong, Ding Liu, Yu Cheng, Chen Fang, Xiaohui Shen, Jianchao Yang, Pan Zhou, and Zhangyang Wang, “EnlightenGAN: Deep Light Enhancement without Paired Supervision”, arXiv:1906.06972v1 [cs.CV], Jun. 17, 2019 (https://arxiv.org/pdf/1906.06972.pdf)

Non-Patent Literature 5: Dongdong Chen, Mingming He, Qingnan Fan, Jing Liao, Liheng Zhang, Dongdong Hou, Lu Yuan, and Gang Hua, “Gated Context Aggregation Network for Image Dehazing and Deraining”, arXiv:1811.08747v2 [cs.CV], Dec. 15, 2018 (https://arxiv.org/abs/1811.08747)

### SUMMARY

A remote operation of a moving body (e.g., a vehicle, a robot) performed by a remote operator is considered. In the remote operation of the moving body, an image captured by a camera installed on the moving body is used. Visibility of the image captured by the camera is affected by environmental conditions such as weather and time. Therefore, in order to improve accuracy of the remote operation, it is conceivable to perform image processing for improving the visibility of the image. In that case, however, although the visibility is improved, other useful information may be lost from the image instead. For example, in a case of rainy/snowy weather, the visibility of the image is improved but an actual road surface condition (road surface μ) may not be correctly communicated to the remote operator, which may affect making a decision to brake and the like.

An object of the present disclosure is to provide a technique capable of providing useful information to a remote operator performing a remote operation of a moving body.

A first aspect is directed to a remote operation system that provides information to a remote operator performing a remote operation of a moving body.

The remote operation system includes one or more processors.

The one or more processors are configured to: acquire an image captured by a camera installed on the moving body;

determine, based on the image, an environmental condition under which the image is captured;

perform visibility improvement processing that improves visibility of the image according to the environmental condition;

present an improved image with the improved visibility to the remote operator; and

when the visibility improvement processing according to a weather condition among environmental conditions is performed, notify the remote operator of assist information including weather at a position of the moving body.

A second aspect is directed to an information providing method for providing information to a remote operator performing a remote operation of a moving body.

The information providing method includes:

acquiring an image captured by a camera installed on the moving body;

determining, based on the image, an environmental condition under which the image is captured;

performing visibility improvement processing that improves visibility of the image according to the environmental condition;

presenting an improved image with the improved visibility to the remote operator; and

when the visibility improvement processing according to a weather condition among environmental conditions is performed, notifying the remote operator of assist information including weather at a position of the moving body.

A third aspect is directed to a remote operator terminal that provides information to a remote operator performing a remote operation of a moving body.

The remote operator terminal includes one or more processors.

The one or more processors are configured to: acquire an image captured by a camera installed on the moving body;

determine, based on the image, an environmental condition under which the image is captured;

perform visibility improvement processing that improves visibility of the image according to the environmental condition;

present an improved image with the improved visibility to the remote operator; and

when the visibility improvement processing according to a weather condition among environmental conditions is performed, notify the remote operator of assist information including weather at a position of the moving body.

According to the present disclosure, the visibility improvement processing is performed according to the environmental condition under which the image is captured by the camera. When the visibility improvement processing according to the weather condition among environmental conditions is performed, not only the improved image is presented to the remote operator but also the assist information including the weather at the position of the moving body is notified to the remote operator. This makes it possible for the remote operator to appropriately perform the remote operation in consideration of not only the improved image with the high visibility but also the actual weather around the moving body. For example, the remote operator is able to appropriately perform the remote operation while accurately grasping the actual road surface condition around the vehicle. Therefore, the accuracy of the remote operation by the remote operator is further improved.

### BRIEF DESCRIPTION OF DRAWINGS

FIG. 1 is a schematic diagram showing a configuration example of a remote operation system according to an embodiment of the present disclosure;

FIG. 2 is a conceptual diagram for explaining an overview of an image improvement unit according to an embodiment of the present disclosure;

FIG. 3 is a block diagram showing a functional configuration example of the image improvement unit according to an embodiment of the present disclosure;

FIG. 4 is a flowchart showing processing by the image improvement unit according to an embodiment of the present disclosure;

FIG. 5 is a conceptual diagram for explaining environmental condition determination processing (Step S20) according to an embodiment of the present disclosure;

FIG. 6 is a flowchart showing an example of visibility improvement processing (Step S30) according to an embodiment of the present disclosure;

FIG. 7 is a conceptual diagram for explaining an overview of assist information notification processing according to an embodiment of the present disclosure;

FIG. 8 is a block diagram showing a functional configuration example related to the assist information notification processing according to an embodiment of the present disclosure;

FIG. 9 is a flowchart showing processing related to the assist information notification processing according to an embodiment of the present disclosure;

FIG. 10 is a diagram showing an example of a correspondence relationship between weather information and assist information according to an embodiment of the present disclosure;

FIG. 11 is a block diagram showing a configuration example of a vehicle according to an embodiment of the present disclosure;

FIG. 12 is a block diagram showing a configuration example of a remote operator terminal according to an embodiment of the present disclosure; and

FIG. 13 is a block diagram showing a configuration example of a management device according to an embodiment of the present disclosure.

### EMBODIMENTS

Embodiments of the present disclosure will be described with reference to the accompanying drawings.

### 1. OVERVIEW OF REMOTE OPERATION SYSTEM

A remote operation (remote driving) of a moving body is considered. Examples of the moving body being a target of the remote operation include a vehicle, a robot, a flying object, and the like. The vehicle may be an autonomous driving vehicle or may be a vehicle driven by a driver. Examples of the robot include a logistics robot, a work robot, and the like. Examples of the flying object include an airplane, a drone, and the like.

As an example, in the following description, a case where the moving body being the target of the remote operation is a vehicle will be considered. When generalizing, “vehicle” in the following description shall be deemed to be replaced with “moving body.”

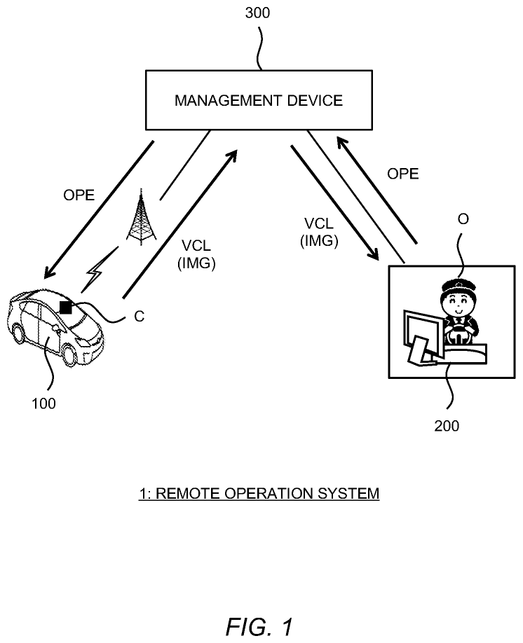

FIG. 1 is a schematic diagram showing a configuration example of a remote operation system 1 according to the present embodiment. The remote operation system 1 includes a vehicle 100, a remote operator terminal 200, and a management device 300. The vehicle 100 is the target of the remote operation. The remote operator terminal 200 is a terminal device used by a remote operator 0 when remotely operating the vehicle 100. The remote operator terminal 200 can also be referred to as a remote operation human machine interface (HMI). The management device 300 manages the remote operation system 1. The management of the remote operation system 1 includes, for example, assigning a remote operator 0 to a vehicle 100 that requires the remote operation. The management device 300 is able to communicate with the vehicle 100 and the remote operator terminal 200 via a communication network. Typically, the management device 300 is a management server on a cloud. The management server may be configured by a plurality of servers that perform distributed processing.

Various sensors including a camera C are installed on the vehicle 100. The camera C images a situation around the vehicle 100 to acquire an image IMG indicating the situation around the vehicle 100. Vehicle information VCL is information acquired by the various sensors and includes the image IMG captured by the camera C. The vehicle 100 transmits the vehicle information VCL to the remote operator terminal 200 via the management device 300. That is, the vehicle 100 transmits the vehicle information VCL to the management device 300, and the management device 300 transfers the received vehicle information VCL to the remote operator terminal 200.

The remote operator station 200 receives the vehicle information VCL transmitted from the vehicle 100. The remote operator terminal 200 presents the vehicle information VCL to the remote operator O. More specifically, the remote operator terminal 200 includes a display device, and displays the image IMG and the like on the display device. The remote operator O views the displayed information, recognizes the situation around the vehicle 100, and performs remote operation of the vehicle 100. The remote operation information OPE is information relating to remote operation by the remote operator O. For example, the remote operation information OPE includes an amount of operation performed by the remote operator O. The remote operator terminal 200 transmits the remote operation information OPE to the vehicle 100 via the management device 300. That is, the remote operator terminal 200 transmits the remote operation information OPE to the management device 300, and the management device 300 transfers the received remote operation information OPE to the vehicle 100.

The vehicle 100 receives the remote operation information OPE transmitted from the remote operator terminal 200. The vehicle 100 performs vehicle travel control in accordance with the received remote operation information OPE. In this manner, the remote operation of the vehicle 100 is realized.

### 2. IMAGE IMPROVEMENT UNIT

### 2-1. Overview

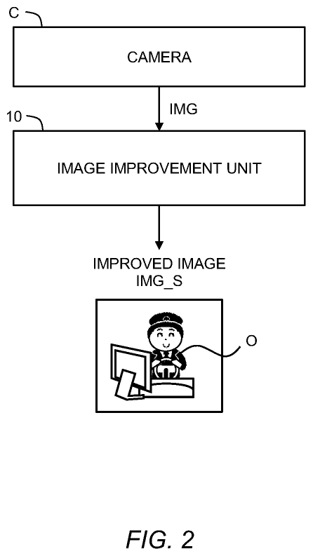

FIG. 2 is a conceptual diagram for explaining an overview of an image improvement unit 10 included in the remote operation system 1 according to the present embodiment. The image improvement unit 10 acquires the image IMG captured by the camera C and improves the image IMG. In particular, the image improvement unit 10 improves “visibility” of the image IMG. The processing for improving the visibility of the image IMG is hereinafter referred to as “visibility improvement processing.” The image whose visibility is improved is hereinafter referred to as an “improved image IMG_S.” The improved image IMG_S with the improved visibility is presented to the remote operator O. As a result, accuracy of recognition by the remote operator O is improved, thereby improving the accuracy of the remote operation.

Various examples can be considered as factors that reduce the visibility of the image IMG captured by the camera C. In the present embodiment, influence of an “environmental condition (scene)” under which the image IMG is captured on the visibility is considered in particular. The environmental condition (scene) means weather, hour, backlight or not, presence or absence of fog, and the like. For example, the visibility of the image IMG captured in rainy weather is low. As another example, the visibility of the image IMG captured in a dark situation such as nighttime is low. As still another example, the visibility of the image IMG captured under a backlight condition is low. As still another example, the visibility of the image IMG captured under a foggy situation is low. As described above, examples of the factors reducing the visibility of the image IMG captured by the camera C include rain, darkness, backlight, fog, and the like.

It is desired to improve the visibility of the image IMG in consideration of such the environmental condition and to acquire the clear improved image IMG_S. However, it is difficult and cumbersome for the remote operator O to decide what processing should be performed in what order for improving the visibility of the image IMG. In view of the above, the image improvement unit 10 according to the present embodiment is configured to be able to automatically determine the factor reducing the visibility of the image IMG captured by the camera C and to execute appropriate visibility improvement processing according to the factor in an appropriate order.

Hereinafter, processing performed by the image improvement unit 10 according to the present embodiment will be described in more detail.

### 2-2. Functional Configuration Example and Processing Example

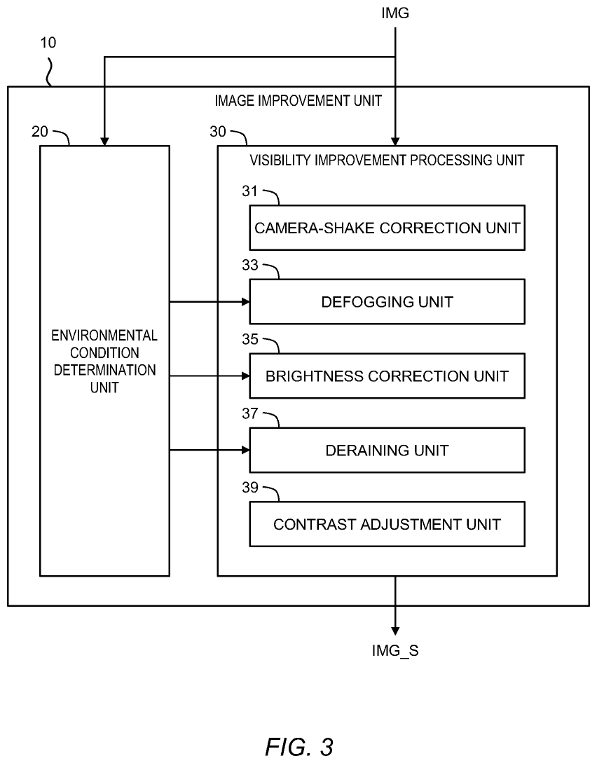

FIG. 3 is a block diagram showing a functional configuration example of the image improvement unit 10 according to the present embodiment. The image improvement unit 10 includes an environmental condition determination unit 20 and a visibility improvement processing unit 30.

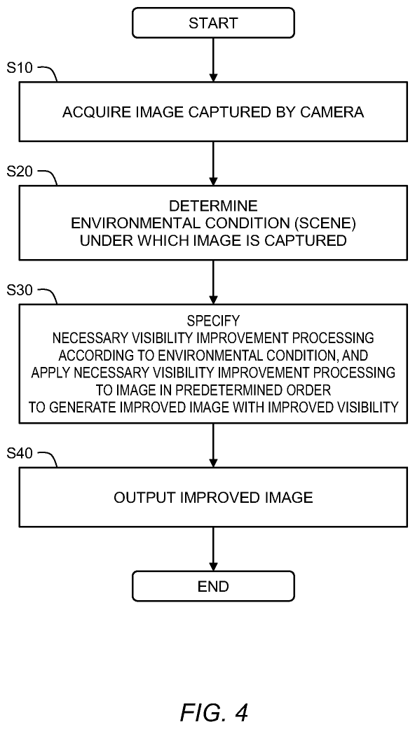

FIG. 4 is a flowchart showing the processing performed by the image improvement unit 10 according to the present embodiment. An example of the processing performed by the image improvement unit 10 according to the present exemplary embodiment will be described below with reference to FIGS. 3 and 4.

2-2-1. Image acquisition processing (Step S10)

The image improvement unit 10 acquires the image IMG captured by the camera C. The image improvement unit 10 transmits the acquired image IMG to the environmental condition determination unit 20 and the visibility improvement processing unit 30.

2-2-2. Environmental condition determination processing (Step S20)

The environmental condition determination unit 20 automatically determines, based on the acquired image IMG, the environmental condition (scene) under which the image IMG is captured. Examples of the technique for determining the environmental condition based on the image IMG include the techniques described in Non-Patent Literature 1 and Non-Patent Literature 2 described above.

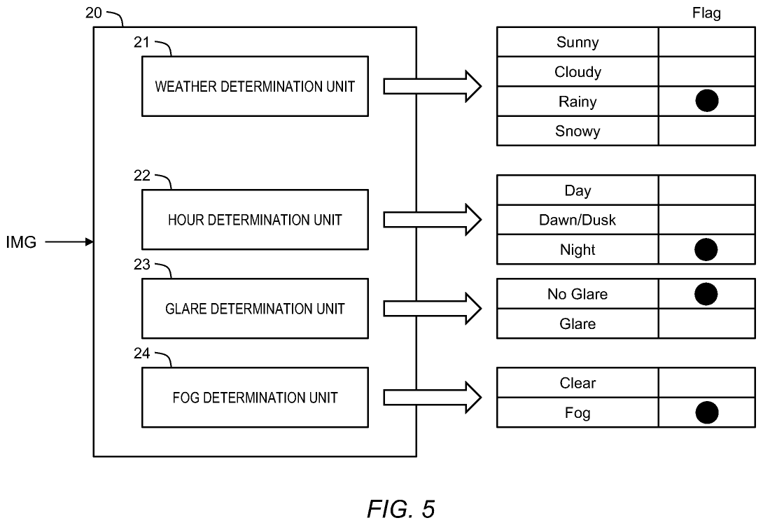

FIG. 5 is a conceptual diagram for explaining the environmental condition determination processing (Step S20). The environmental condition determination unit 20 includes a weather determination unit 21, an hour determination unit 22, a glare determination unit 23, and a fog determination unit 24.

Based on the image IMG, the weather determination unit 21 determines the weather when the image IMG is captured. Examples of the weather include sunny, cloudy, rainy, and snowy. The weather determination unit 21 outputs the determined weather.

Based on the image IMG, the hour determination unit 22 determines an hour when the image IMG is captured. Examples of the hour include day, dawn/dusk, and night. The “night” corresponds to “darkness.” The hour determination unit 22 outputs the determined hour.

Based on the image IMG, the glare determination unit 23 determines whether or not the image IMG is captured under a backlight condition. The glare determination unit 23 outputs whether or not it is the backlight condition.

Based on the image IMG, the fog determination unit 24 determines presence or absence of fog when the image IMG is captured. The fog determination unit 24 outputs the presence or absence of fog.

The environmental condition under which the image IMG is captured is a combination of outputs from the weather determination unit 21, the hour determination unit 22, the glare determination unit 23, and the fog determination unit 24. In the example shown in FIG. 5, the environmental condition is “rainy & night (darkness) & no backlight & fog.” The environmental condition determination unit 20 outputs information on the acquired environmental condition to the visibility improvement processing unit 30.

2-2-3. Visibility improvement processing (Step S30)

The visibility improvement processing unit 30 receives the image IMG and the information on the environmental condition under which the image IMG is captured. Then, the visibility improvement processing unit 30 specifies the visibility improvement processing required for improving the visibility of the image IMG according to the environmental condition.

The visibility improvement processing required when the environmental condition includes “fog” is “fog removing processing (defogging).” The defogging removes haze caused by fog in the image IMG to improve the visibility. This defogging is realized by, for example, the technique described in the above-mentioned Non-Patent Literature 3.

The visibility improvement processing required when the environmental condition includes “darkness” or “backlight” is “brightness correction processing.” The brightness correction processing corrects the image IMG captured in the scene such as nighttime or backlight to have appropriate brightness to improve the visibility. The brightness correction processing is realized by, for example, the technique described in the above-mentioned Non-Patent Literature 4.

The visibility improvement processing required when the environmental condition includes “rain” is “rain removing processing (deraining).” The deraining removes haze caused by rain in the image IMG to improve the visibility. This deraining is realized by, for example, the technique described in the above-mentioned Non-Patent Literature 5.

As described above, there are three types of processing as candidates for the visibility improvement processing related to the environmental condition: defogging, brightness correction processing, and deraining. Research was made as to in what order to perform the multiple types of visibility improvement processing for obtaining the highest visibility improvement effect. As a result of the research efforts, it is found that the highest visibility improvement effect is obtained when “1. defogging”, “2. brightness correction processing”, and “3. deraining” are performed in this order. This order is adopted in the present embodiment. That is, the processing order is predetermined such that the defogging is performed before the brightness correction processing and the brightness correction processing is executed before the deraining.

The visibility improvement processing unit 30 specifies necessary visibility improvement processing from among the multiple types of processing candidates (i.e., defogging, brightness correction processing, and deraining) according to the environmental condition determined by the environmental condition determination unit 20. The processing order of the multiple types of processing candidates is predetermined. The visibility improvement processing unit 30 applies the specified necessary visibility improvement processing to the image IMG in the predetermined order to generate the improved image IMG_S with the improved visibility. In other words, the visibility improvement processing unit 30 performs the necessary visibility improvement processing not blindly but according to the predetermined order. As a result, an excellent visibility improvement effect can be obtained, and thus the improved image IMG_S that is as clear as possible can be obtained.

It should be noted that the multiple types of processing candidates related to the environmental condition may include any two of the defogging, the brightness correction processing, and the deraining. The processing order in that case is also the same.

The visibility improvement processing unit 30 may further perform visibility improvement processing that is unrelated to the environmental condition. For example, the visibility improvement processing unit 30 may perform well-known image processing such as camera-shake correction processing and contrast adjustment processing (averaging).

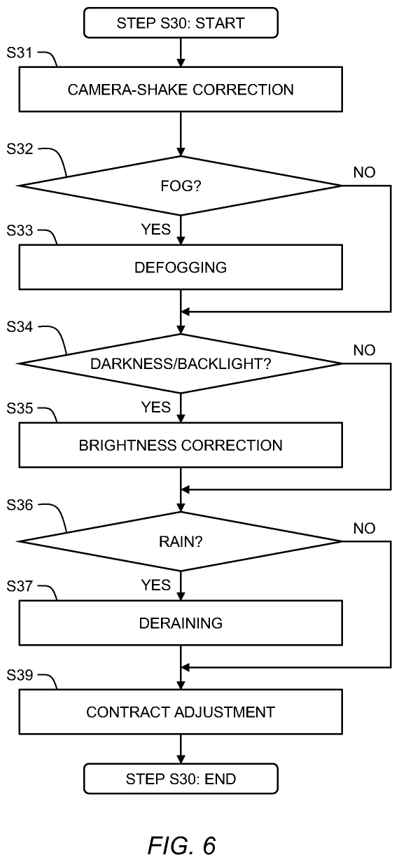

Hereinafter, an example of the visibility improvement processing by the visibility improvement processing unit 30 will be described. As shown in FIG. 3, the visibility improvement processing unit 30 includes a camera-shake correction unit 31, a defogging unit 33, a brightness correction unit 35, a deraining unit 37, and a contrast adjustment unit 39. FIG. 6 is a flowchart showing an example of the visibility improvement processing (Step S30).

In Step S31, the camera-shake correction unit 31 performs the well-known camera-shake correction processing with respect to the image IMG. The camera-shake correction unit 31 outputs the image IMG after the camera-shake correction processing to the defogging unit 33.

In subsequent Step S32, the defogging unit 33 determines whether or not the environmental condition determined by the environmental condition determination unit 20 includes “fog.” When the environmental condition includes “fog” (Step S32; Yes), the defogging unit 33 determines that the defogging is necessary, and performs the defogging (Step S33). Then, the defogging unit 33 outputs the image IMG after the defogging to the brightness correction unit 35. On the other hand, when the environmental condition does not include “fog” (Step S32; No), the defogging unit 33 outputs the image IMG to the brightness correction unit 35 without performing the defogging.

In subsequent Step S34, the brightness correction unit 35 determines whether or not the environmental condition determined by the environmental condition determination unit 20 includes “darkness” or “backlight.” When the environmental condition includes “darkness” or “backlight” (Step S34; Yes), the brightness correction unit 35 determines that the brightness correction processing is necessary, and performs the brightness correction processing (Step S35). Then, the brightness correction unit 35 outputs the image IMG after the brightness correction processing to the deraining unit 37. On the other hand, when the environmental condition includes neither “darkness” nor “backlight” (Step S34; No), the brightness correction unit 35 outputs the image IMG to the deraining unit 37 without performing the brightness correction processing.

In subsequent Step S36, the deraining unit 37 determines whether or not the environmental condition determined by the environmental condition determination unit 20 includes “rain.” When the environmental condition includes “rain” (Step S36; Yes), the deraining unit 37 determines that the deraining is necessary, and performs the deraining (Step S37). Then, the deraining unit 37 outputs the image IMG after the deraining to the contrast adjustment unit 39. On the other hand, when the environmental condition does not include “rain” (Step S36; No), the deraining unit 37 outputs the image IMG to the contrast adjustment unit 39 without performing the deraining.

In subsequent Step S39, the contrast adjustment unit 39 performs the well-known contrast adjustment processing with respect to the image IMG.

The image IMG thus subjected to the visibility improvement processing step by step is the improved image IMG_S.

2-2-4. Image output processing (Step S40)

The image improvement unit 10 outputs the improved image IMG_S thus generated to the outside. For example, the improved image IMG_S is presented to the remote operator O by the remote operator terminal 200.

### 2-3. Effects

As described above, the image improvement unit 10 according to the present embodiment determines, based on the image IMG captured by the camera C, the environmental condition under which the image IMG is captured. Further, the image improvement unit 10 specifies the necessary visibility improvement processing according to the environmental condition, and applies the necessary visibility improvement processing to the image IMG in the predetermined order to generate the improved image IMG_S. Since the appropriate visibility improvement processing according to the factor reducing the visibility is executed in the appropriate order, an excellent visibility improvement effect can be obtained. In addition, since individual judgment by the remote operator O is unnecessary, the load on the remote operator O is reduced. The remote operator O is able to easily acquire the improved image IMG_S with the improved visibility.

The remote operator O is able to perform the remote operation based on the improved image IMG_S. The visibility of the image IMG may be reduced depending on the environmental condition under which the vehicle 100 is placed. Even in such a case, the clear improved image IMG_S in which the influence of the environmental condition is reduced can be used. As a result, the accuracy of recognition by the remote operator O is improved, and thus the accuracy of the remote operation also is improved. In addition, since the influence of the environmental condition is reduced, it is possible to expand an operational design domain (ODD). This is preferable from a viewpoint of service improvement.

It should be noted that the image improvement unit 10 according to the present embodiment may be included in any of the vehicle 100, the remote operator terminal 200, and the management device 300. That is, at least one of the vehicle 100, the remote operator terminal 200, and the management device 300 has the function of the image improvement unit 10. For example, the image improvement unit 10 is incorporated in the management device 300. In this case, the management device 300 generates the improved image IMG_S by improving the visibility of the image IMG received from the vehicle 100, and transmits the improved image IMG_S to the remote operator terminal 200. As another example, the image improvement unit 10 may be incorporated in the remote operator terminal 200. In this case, the remote operator terminal 200 improves the visibility of the image IMG received from the vehicle 100 via the management device 300 to generate the improved image IMG_S. In either case, the remote operator terminal 200 is able to present the improved image IMG_S with the improved visibility to the remote operator O.

### 3. ASSIST INFORMATION NOTIFICATION PROCESSING

### 3-1. Overview

Due to the visibility improvement processing described above, the remote operator O is able to perform the remote operation based on the improved image IMG_S with the improved visibility, and thus the accuracy of the remote operation is also improved. In that case, however, although the visibility is improved, other useful information may be lost from the image IMG instead.

For example, in a case of rainy/snowy weather, a road surface friction coefficient (road surface μ) decreases and a stopping distance at the time of braking increases, and thus the remote operator O may consider starting a braking operation early. However, as a result of the visibility of the image IMG being improved by the visibility improvement processing, an actual road surface condition may not be correctly communicated to the remote operator O. This may affect the remote operator O's decision to brake and the like.

In view of the above, the remote operator terminal 200 according to the present embodiment is configured to notify (provide, transmit) “assist information AST” to the remote operator O as necessary. The assist information AST is information useful for the remote operator O, and particularly information for supporting the remote operation by the remote operator O. Processing of notifying the remote operator O of the assist information AST is hereinafter referred to as “assist information notification processing.”

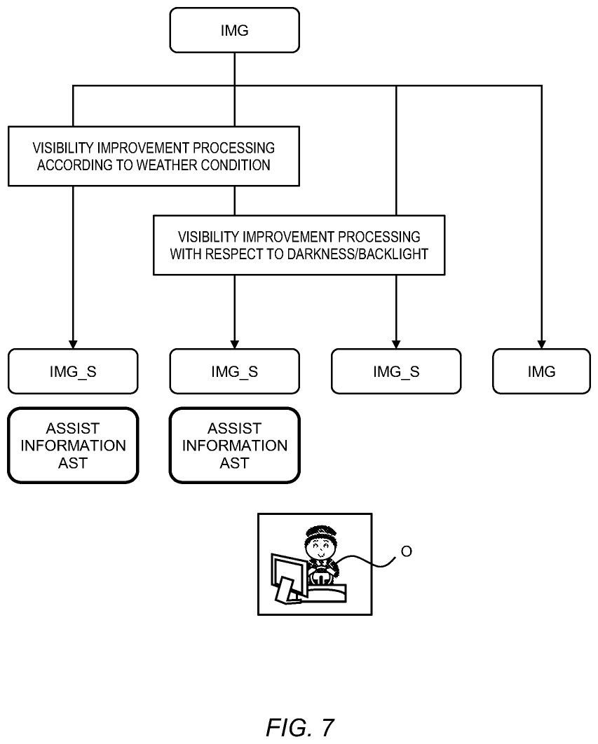

FIG. 7 is a conceptual diagram for explaining an overview of the assist information notification processing. The “environmental conditions” under which the image IMG is captured by the camera C are classified into a “weather condition” and other conditions. Examples of the weather condition include sunny, cloudy, rainy, snowy, foggy, etc. Examples of the environmental condition other than the weather condition include darkness, backlight, and the like. Examples of the visibility improvement processing according to the weather condition among the environmental conditions include the defogging (FIG. 6; Step S33) and the deraining (FIG. 6; Step S37).

A case in which the visibility improvement processing according to the weather condition among the environmental conditions is performed is considered. In this case, the remote operator terminal 200 presents the improved image IMG_S with the improved visibility to the remote operator O. At the same time, the remote operator terminal 200 notifies the remote operator O of the assist information AST including weather (e.g., rain, snow, fog) at a position of the vehicle 100. That is to say, triggered by the fact that the visibility improvement processing according to the weather condition is performed, the remote operator terminal 200 notifies the remote operator O of the assist information AST including the weather. In other words, the remote operator terminal 200 notifies the remote operator O of the assist information AST including the weather in conjunction with the visibility improvement processing according to the weather condition. This makes it possible for the remote operator O to appropriately perform the remote operation in consideration of not only the improved image IMG_S with the high visibility but also the actual weather around the vehicle 100. For example, the remote operator O is able to appropriately perform the remote operation while accurately grasping the actual road surface condition around the vehicle 100. Therefore, the accuracy of the remote operation by the remote operator O is further improved.

The assist information AST may include advice (e.g., “brake early!”) to the remote operator O in performing the remote operation of the vehicle 100. At a time of heavy weather, the assist information AST may include a warning to the remote operator O (e.g., “be careful of heavy rain!”, “be careful of heavy snow!”). Such the assist information AST is also useful for the remote operator O. Notifying the remote operator O of such the assist information AST further improves safety of the remote operation by the remote operator O.

When the visibility improvement processing according to the weather condition is not performed, it is not necessary to notify the remote operator O of the assist information AST. For example, in a case where the visibility improvement processing according to the weather condition is not performed and only the visibility improvement processing (the brightness correction processing) for darkness and backlight is performed, the improved image IMG_ S is presented to the remote operator O, but the assist information AST is not notified to the remote operator O. As another example, in a case where the visibility improvement processing is not performed at all, the original image IMG is presented to the remote operator O, and the remote operator O is not notified of the assist information AST. Since the assist information AST is not notified more than necessary, the remote operator O is prevented from feeling annoyed.

Hereinafter, the assist information notification processing according to the present embodiment will be described in more detail.

### 3-2. Functional Configuration Example and Processing Example

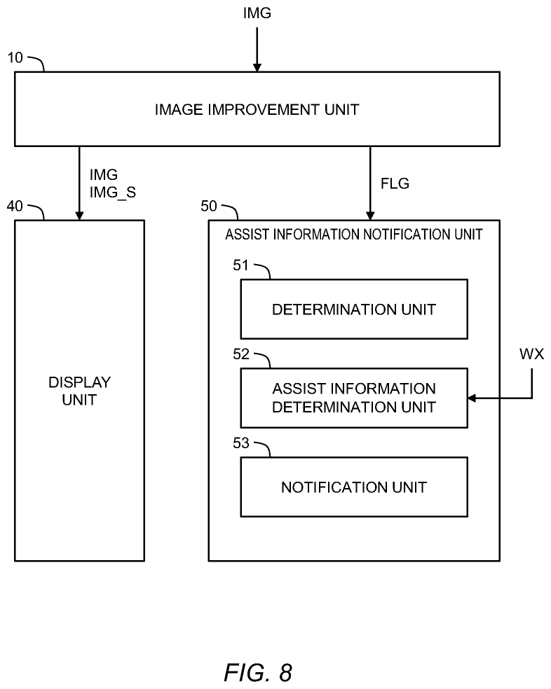

FIG. 8 is a block diagram showing an example of a functional configuration related to the assist information notification processing. The remote operation system 1 includes the image improvement unit 10, a display unit 40, and an assist information notification unit 50.

The image improvement unit 10 is included in any of the vehicle 100, the remote operator terminal 200, and the management device 300. The image improvement unit 10 performs the visibility improvement processing with respect to the image IMG as necessary to output the improved image IMG_S. Furthermore, the image improvement unit 10 outputs flag information FLG indicating a content of the visibility improvement processing. For example, the flag information FLG indicates performed processing among the defogging (FIG. 6; Step S33), the brightness correction processing (FIG. 6; Step S35), and the deraining (FIG. 6; Step S37).

The display unit 40 is included in the remote operator terminal 200. The display unit 40 displays the original image IMG or the improved image IMG_S on a display device.

The assist information notification unit 50 is included in the remote operator terminal 200. The assist information notification unit 50 executes the assist information notification processing that notifies the remote operator O of the assist information AST as necessary. The assist information notification unit 50 includes a determination unit 51, an assist information determination unit 52, and a notification unit 53.

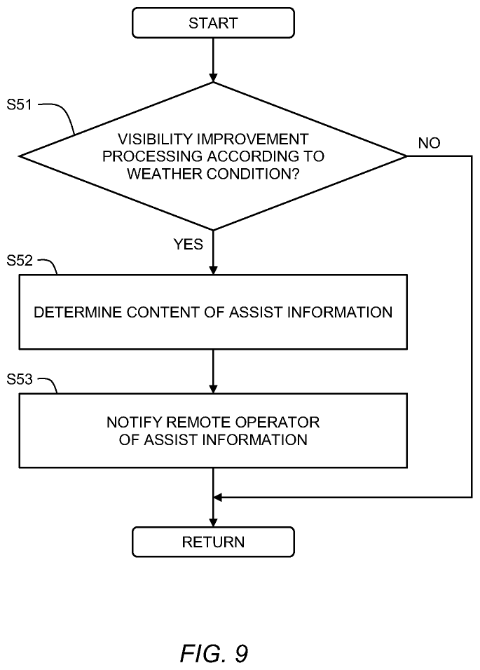

FIG. 9 is a flowchart showing processing related to the assist information notification processing. Hereinafter, the processing related to the assist information notification processing will be described with reference to FIGS. 8 and 9.

3-2-1. Determination processing (Step S51)

In Step S51, the determination unit 51 determines whether or not the visibility improvement processing according to the weather condition among the environmental conditions is performed. More specifically, the determination unit 51 receives the flag information FLG output from the image improvement unit 10. The flag information FLG indicates the content of the visibility improvement processing performed by the image improvement unit 10. Based on the flag information FLG, the determination unit 51 can determine whether or not the visibility improvement processing according to the weather condition is performed.

When the visibility improvement processing according to the weather condition is performed (Step S51; Yes), the processing proceeds to Step S52. On the other hand, when the visibility improvement processing according to the weather condition is not performed (Step S51; No), subsequent steps S52 and S53 are skipped, and the processing in the current cycle ends.

3-2-2. Assist information determination processing (Step S52)

In Step S52, the assist information determination unit 52 determines a content of the assist information AST to be notified to the remote operator O.

The assist information AST includes at least the weather (e.g., rain, snow, fog) at the position of the vehicle 100. The position of the vehicle 100 is included in the vehicle information VCL transmitted from the vehicle 100. For example, the assist information determination unit 52 communicates with a weather information service center that distributes weather information WX to acquire the weather information WX at the position of the vehicle 100.

The assist information AST may include advice (e.g., “brake early!”) to the remote operator O in performing the remote operation of the vehicle 100. By notifying the remote operator O of such the assist information AST, the safety of the remote operation by the remote operator O is further improved.

The assist information determination unit 52 may recognize a “degree of heavy weather” at the position of the vehicle 100 based on the weather information WX at the position of the vehicle 100. Then, the assist information determination unit 52 may change the content of the assist information AST according to the degree of heavy weather. For example, when the degree of heavy weather is equal to or greater than a threshold value, the assist information determination unit 52 determines the content of the assist information AST so as to include a warning to the remote operator O.

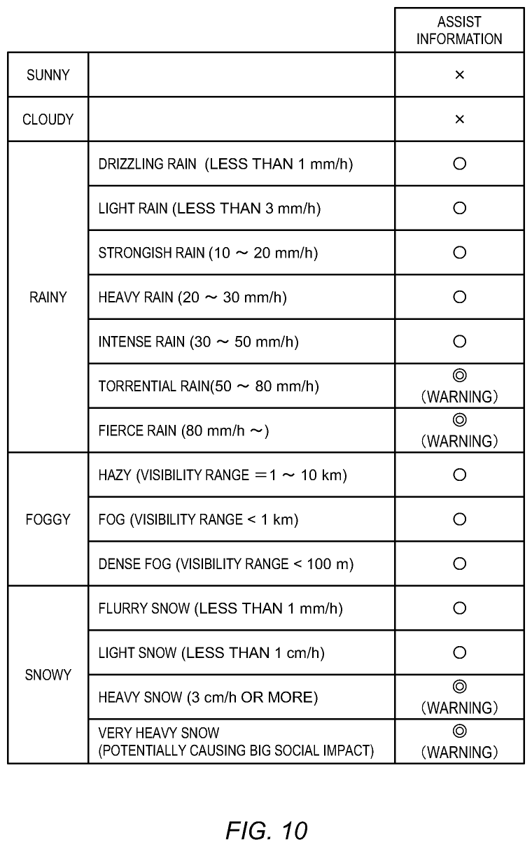

FIG. 10 shows an example of a correspondence relationship between the weather information WX and the assist information AST. For example, in a case where the amount of rainfall per hour is equal to or greater than a threshold value (50 mm/h), the assist information AST includes a warning (e.g., “be careful of heavy rain!”). As another example, in a case where the amount of snowfall per hour is equal to or greater than a threshold value (3cm/h), the assist information AST includes a warning (e.g., “be careful of heavy snow!”). By notifying the remote operator O of such the assist information AST, the safety of the remote operation by the remote operator O is further improved.

3-2-3. Notification processing (Step S53)

The notification unit 53 notifies the remote operator O of the assist information AST determined in Step S52. The notification may be performed visually or auditorily. For example, the notification unit 53 displays the assist information AST on the display device. As another example, the notification unit 53 outputs an audio assist information AST through a speaker.

### 3-3. Effects

As described above, according to the present embodiment, the visibility improvement processing is performed according to the environmental condition under which the image IMG is captured by the camera C. When the visibility improvement processing according to the weather condition among the environmental conditions is performed, not only the improved image IMG_S is presented to the remote operator O but also the remote operator O is notified of the assist information AST including the weather at the position of the vehicle 100. This makes it possible for the remote operator O to appropriately perform the remote operation in consideration of not only the improved image IMG_S with the high visibility but also the actual weather around the vehicle 100. For example, the remote operator O is able to appropriately perform the remote operation while accurately grasping the actual road surface condition around the vehicle 100. Therefore, the accuracy of the remote operation by the remote operator O is further improved.

When the visibility improvement processing according to the weather condition is not performed, the remote operator O is not notified of the assist information AST. Since the assist information AST is not notified more than necessary, the remote operator O is prevented from feeling annoyed.

### 4. EXAMPLE OF VEHICLE

### 4-1. Configuration Example

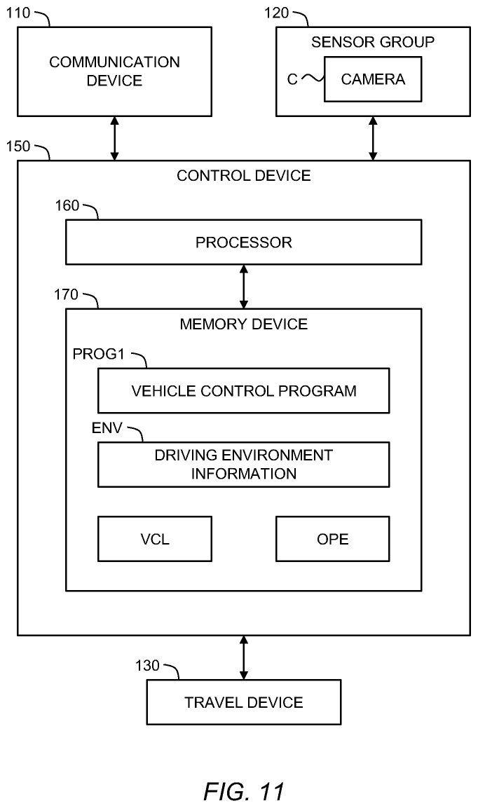

FIG. 11 is a block diagram showing a configuration example of the vehicle 100. The vehicle 100 includes a communication device 110, a sensor group 120, a travel device 130, and a control device (controller) 150.

The communication device 110 communicates with the outside of the vehicle 10. For example, the communication device 110 communicates with the remote operator terminal 200 and the management device 300.

The sensor group 120 includes a recognition sensor, a vehicle state sensor, a position sensor, and the like. The recognition sensor recognizes (detects) a situation around the vehicle 100. Examples of the recognition sensor include the camera C, a laser imaging detection and ranging (LIDAR), a radar, and the like. The vehicle state sensor detects a state of the vehicle 100. Examples of the vehicle state sensor include a speed sensor, an acceleration sensor, a yaw rate sensor, a steering angle sensor, and the like. The position sensor detects a position and an orientation of the vehicle 10. For example, the position sensor includes a global navigation satellite system (GNSS).

The travel device 130 includes a steering device, a driving device, and a braking device. The steering device turns wheels. For example, the steering device includes an electric power steering (EPS) device. The driving device is a power source that generates a driving force. Examples of the drive device include an engine, an electric motor, an in-wheel motor, and the like. The braking device generates a braking force.

The control device 150 is a computer that controls the vehicle 10. The control device 150 includes one or more processors 160 (hereinafter simply referred to as a processor 160) and one or more memory devices 170 (hereinafter simply referred to as a memory device 170). The processor 160 executes a variety of processing. For example, the processor 160 includes a central processing unit (CPU). The memory device 170 stores a variety of information necessary for the processing by the processor 160. Examples of the memory device 170 include a volatile memory, a non-volatile memory, a hard disk drive (HDD), a solid state drive (SSD), and the like. The control device 150 may include one or more electronic control units (ECUs).

A vehicle control program PROG1 is a computer program executed by the processor 160. The functions of the control device 150 are implemented by the processor 160 executing the vehicle control program PROG1. The vehicle control program PROG1 is stored in the memory device 170. The vehicle control program PROG1 may be recorded on a non-transitory computer-readable recording medium.

### 4-2. Driving Environment Information

The control device 150 uses the sensor group 120 to acquire driving environment information ENV indicating a driving environment for the vehicle 100. The driving environment information ENV is stored in the memory device 170.

The driving environment information ENV includes surrounding situation information indicating a result of recognition by the recognition sensor. For example, the surrounding situation information includes the image IMG captured by the camera C. The surrounding situation information further includes object information regarding an object around the vehicle 10. Examples of the object around the vehicle 100 include a pedestrian, another vehicle (e.g., a preceding vehicle, a parked vehicle, etc.), a white line, a traffic signal, a sign, a roadside structure, and the like. The object information indicates a relative position and a relative velocity of the object with respect to the vehicle 10.

In addition, the driving environment information ENV includes vehicle state information indicating the vehicle state detected by the vehicle state sensor.

Furthermore, the driving environment information ENV includes vehicle position information indicating the position and the orientation of the vehicle 100. The vehicle position information is acquired by the position sensor. Highly accurate vehicle position information may be acquired by performing a well-known localization using map information and the surrounding situation information (the object information).

### 4-3. Vehicle Travel Control

The control device 150 executes vehicle travel control that controls travel of the vehicle 100. The vehicle travel control includes steering control, driving control, and braking control. The control device 150 executes the vehicle travel control by controlling the travel device 130 (i.e., the steering device, the driving device, and the braking device).

The control device 150 may execute autonomous driving control based on the driving environment information ENV. More specifically, the control device 150 generates a travel plan of the vehicle 100 based on the driving environment information ENV. Further, the control device 150 generates, based on the driving environment information ENV, a target trajectory required for the vehicle 100 to travel in accordance with the travel plan. The target trajectory includes a target position and a target speed. Then, the control device 150 executes the vehicle travel control such that the vehicle 100 follows the target trajectory.

### 4-4. Processing Related to Remote Operation

Hereinafter, the case where the remote operation of the vehicle 100 is performed will be described. The control device 150 communicates with the remote operator terminal 200 via the communication device 110.

The control device 150 transmits the vehicle information VCL to the remote operator terminal 200. The vehicle information VCL is information necessary for the remote operation by the remote operator O, and includes at least a part of the driving environment information ENV described above. For example, the vehicle information VCL includes the surrounding situation information (especially, the image IMG). The vehicle information VCL may further include the vehicle state information and the vehicle position information.

In addition, the control device 150 receives the remote operation information OPE from the remote operator terminal 200. The remote operation information OPE is information regarding the remote operation by the remote operator O. For example, the remote operation information OPE includes an amount of operation performed by the remote operator O. The control device 150 performs the vehicle travel control in accordance with the received remote operation information OPE.

Furthermore, the control device 150 may have the function of the image improvement unit 10 described above. The image improvement unit 10 performs the visibility improvement processing with respect to the image IMG as necessary to output the improved image IMG_S. In addition, the image improvement unit 10 outputs the flag information FLG indicating the content of the visibility improvement processing. The improved image IMG_S and the flag information FLG are transmitted as a part of the vehicle information VCL to the management device 300 and the remote operator terminal 200.

### 5. EXAMPLE REMOTE OPERATOR TERMINAL

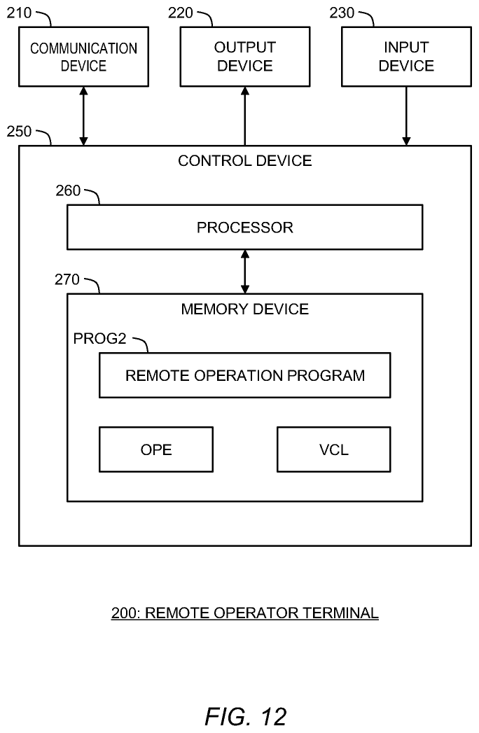

FIG. 12 is a block diagram showing a configuration example of the remote operator terminal 200. The remote operator station 200 includes a communication device 210, an output device 220, an input device 230, and a control device (controller) 250.

The communication device 210 communicates with the vehicle 100 and the management device 300.

The output device 220 outputs a variety of information. For example, the output device 220 includes a display device. The display device presents a variety of information to the remote operator O by displaying the variety of information. As another example, the output device 220 may include a speaker.

The input device 230 receives an input from the remote operator O. For example, the input device 230 includes a remote operation member that is operated by the remote operator O when remotely operating the vehicle 100. The remote operation member includes a steering wheel, an accelerator pedal, a brake pedal, a direction indicator, and the like.

The control device 250 controls the remote operator terminal 200. The control device 250 includes one or more processors 260 (hereinafter simply referred to as a processor 260) and one or more memory devices 270 (hereinafter simply referred to as a memory device 270). The processor 260 executes a variety of processing. For example, the processor 260 includes a CPU. The memory device 270 stores a variety of information necessary for the processing by the processor 260. Examples of the memory device 270 include a volatile memory, a non-volatile memory, an HDD, an SSD, and the like.

A remote operation program PROG2 is a computer program executed by the processor 260. The functions of the control device 250 are implemented by the processor 260 executing the remote operation program PROG2. The remote operation program PROG2 is stored in the memory device 270. The remote operation program PROG2 may be recorded on a non-transitory computer-readable recording medium. The remote operation program PROG2 may be provided via a network.

The control device 250 communicates with the vehicle 100 via the communication device 210. The control device 250 receives the vehicle information VCL transmitted from the vehicle 100. The control device 250 presents the vehicle information VCL to the remote operator O by displaying the vehicle information VCL including the image information on the display device. The remote operator O is able to recognize the state of the vehicle 100 and the situation around the vehicle 100 based on the vehicle information VCL displayed on the display device.

The remote operator O operates the remote operation member of the input device 230. An operation amount of the remote operation member is detected by a sensor installed on the remote operation member. The control device 250 generates the remote operation information OPE reflecting the operation amount of the remote operation member operated by the remote operator O. Then, the control device 250 transmits the remote operation information OPE to the vehicle 100 via the communication device 210.

Furthermore, the control device 250 may have the function of the image improvement unit 10 described above. The image improvement unit 10 performs the visibility improvement processing with respect to the image IMG as necessary to output the improved image IMG_S. In addition, the image improvement unit 10 outputs the flag information FLG indicating the content of the visibility improvement processing.

The control device 250 has the function of the assist information notification unit 50 described above. The assist information notification unit 50 notifies the remote operator O of the assist information AST through the output device 220.

### 6. EXAMPLE MANAGEMENT DEVICE

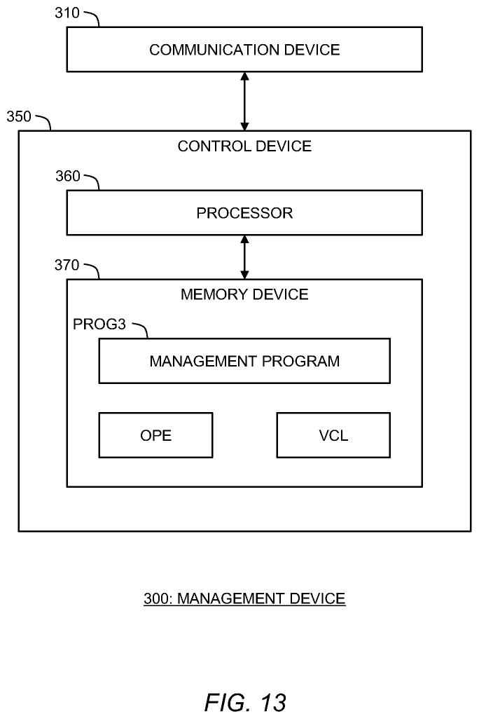

FIG. 13 is a block diagram showing a configuration example of the management device 300. The management device 300 includes a communication device 310 and a control device 350.

The communication device 310 communicates with the vehicle 100 and remote operator terminal 200.

The control device (controller) 350 controls the management device 300. The control device 350 includes one or more processors 360 (hereinafter simply referred to as a processor 360) and one or more memory devices 370 (hereinafter simply referred to as a memory device 370). The processor 360 executes a variety of processing. For example, the processor 360 includes a CPU. The memory device 370 stores a variety of information necessary for the processing by the processor 360. Examples of the memory device 370 include a volatile memory, a non-volatile memory, an HDD, an SSD, and the like.

A management program PROG3 is a computer program executed by the processor 360. The functions of the control device 350 are implemented by the processor 360 executing the management program PROG3. The management program PROG3 is stored in the memory device 370. The management program PROG3 may be recorded on a non-transitory computer-readable recording medium. The management program PROG3 may be provided via a network.

The control device 350 communicates with the vehicle 100 and the remote operator terminal 200 via the communication device 310. The control device 350 receives the vehicle information VCL transmitted from the vehicle 100. Then, the control device 350 transmits the received vehicle information VCL to the remote operator terminal 200. In addition, the control device 350 receives the remote operation information OPE transmitted from the remote operator terminal 200. Then, the control device 350 transmits the received remote operation information OPE to the vehicle 100.

Furthermore, the control device 350 may have the function of the image improvement unit 10 described above. When the image IMG is included in the vehicle information VCL received from the vehicle 100, the image improvement unit 10 performs the visibility improvement processing with respect to the image IMG as necessary to output the improved image IMG_S. In addition, the image improvement unit 10 outputs the flag information FLG indicating the content of the visibility improvement processing. The improved image IMG_S and the flag information FLG are transmitted as a part of the vehicle information VCL to the remote operator terminal 200.

What is claimed is:

1. A remote operation system that provides information to a remote operator performing a remote operation of a moving body,
the remote operation system comprising one or more processors configured to:
acquire an image captured by a camera installed on the moving body;
determine, based on the image, an environmental condition under which the image is captured;
perform visibility improvement processing that improves visibility of the image according to the environmental condition;
present an improved image with the improved visibility to the remote operator; and
when the visibility improvement processing according to a weather condition among environmental conditions is performed, notify the remote operator of assist information including weather at a position of the moving body.

2. The remote operation system according to claim 1, wherein
when the visibility improvement processing according to the weather condition is not performed, the one or more processors refrain from notifying the remote operator of the assist information.

3. The remote operation system according to claim 1, wherein
the assist information includes advice to the remote operator in performing the remote operation of the moving body, in addition to the weather.

4. The remote operation system according to claim 1, wherein
the one or more processors are further configured to:
recognize a degree of heavy weather at the position of the moving body based on weather information at the position of the moving body; and
change a content of the assist information according to the degree of heavy weather.

5. The remote operation system according to claim 4, wherein
the assist information in a case where the degree of heavy weather is equal to or greater than a threshold value includes a warning to the remote operator.

6. An information providing method for providing information to a remote operator performing a remote operation of a moving body,
the information providing method comprising:
acquiring an image captured by a camera installed on the moving body;
determining, based on the image, an environmental condition under which the image is captured;
performing visibility improvement processing that improves visibility of the image according to the environmental condition;
presenting an improved image with the improved visibility to the remote operator; and
when the visibility improvement processing according to a weather condition among environmental conditions is performed, notifying the remote operator of assist information including weather at a position of the moving body.

7. A remote operator terminal that provides information to a remote operator performing a remote operation of a moving body,
the remote operator terminal comprising one or more processors configured to:
acquire an image captured by a camera installed on the moving body;
determine, based on the image, an environmental condition under which the image is captured;
perform visibility improvement processing that improves visibility of the image according to the environmental condition;
present an improved image with the improved visibility to the remote operator; and
when the visibility improvement processing according to a weather condition among environmental conditions is performed, notify the remote operator of assist information including weather at a position of the moving body.
